(19) United States
(12) Patent Application Publication
(10) Pub. No.: US 2026/0317929 A1
(43) Pub. Date: Oct. 15, 2026

(54) CONTROL CIRCUIT AND CONTROL METHOD FOR DUAL ELECTROLYZED WATER PREPARATION DEVICE BASED ON PARALLEL PREPARATION OF O3 AND H2O2

(71) Applicant: Ningbo Yuanpai Medical Technology Co., Ltd., Ningbo City (CN)

(72) Inventor: Zhengping Liu, Ningbo City (CN)

(21) Appl. No.: 19/453,131

(22) Filed: Jan. 20, 2026

(30) Foreign Application Priority Data
Apr. 9, 2025 (CN) 202510438543.X

(51) Int. Cl. C25B 15/023; C25B 1/13; C25B 1/30; C25B 9/65; H02M 3/156

(52) U.S. Cl. CPC C25B 15/023; C25B 1/13; C25B 1/30; C25B 9/65; H02M 3/156

(57) ABSTRACT

The present invention discloses a control circuit and a control method for a dual electrolyzed water preparation device based on parallel preparation of O₃ and H₂O₂. The key points of the technical solutions of the present invention are as follows: comprising: a touch key module interacting with an operator to output a start signal or a stop signal in response to an action of the operator; a load driving module connected to the touch key module for obtaining the start signal or the stop signal to start or stop a load; and a self-cleaning maintenance module connected to the load driving module for controlling output electrodes of the load driving module to perform polarity reversal and maintain normal operation of the load.

### CROSS-REFERENCE TO RELATED APPLICATIONS

This is a U.S. patent application which claims the priority and benefit of Chinese Patent Application Number 202510438543.X, filed on Apr. 9, 2025, the disclosure of which is incorporated herein by reference in its entirety.

### TECHNICAL FIELD

The present invention relates to control circuits, and more specifically, to a control circuit and a control method for a dual electrolyzed water preparation device based on parallel preparation of O₃ and H₂O₂.

### BACKGROUND ART

In the market, electrolyzed pure water prepared by dual electrolysis is widely used in industries such as semiconductors, pharmaceuticals, laboratories, and electric power. For example, in semiconductor manufacturing, ultrapure water is a key raw material for wafer cleaning and chemical preparation, and any trace impurities may affect chip performance; in the pharmaceutical field, high-purity water is an essential condition for the production of injections and biological agents; in laboratories, ultrapure water is used for precision experiments and analysis. In addition, with the improvement of environmental protection requirements and industrial upgrading, dual electrolysis technology has broad application prospects in the field of water treatment. Especially in high-end manufacturing and scientific research fields that have extremely high requirements for water quality, its market demand continues to grow. In the future, with technological progress and cost optimization, the technology of preparing electrolyzed pure water by dual electrolysis is expected to achieve large-scale application in more fields.

However, due to ion migration and chemical combination reactions that occur in the electrolysis process, under conditions of relatively complex water quality (e.g., water containing rust, hardness exceeding a certain value, organic substances, etc.), the electrolyzed drinking water exhibits poor taste, peculiar smell, and precipitation, and even causes the electrolyzed water machine to stop operating. This natural defect of the electrolyzed water machine makes it difficult for the electrolyzed water machine to be accepted by more consumers and to be promoted worldwide.

A Chinese patent with publication number CN105923858A discloses an electrolyzed water device composed of an RO membrane and an electrolytic cell. Its key technical points are as follows: the RO membrane is in front of the electrolytic cell with a dual-channel water inlet structure; the purified water end of the RO membrane is connected to the main water inlet end of the electrolytic cell through the electrolytic cell water inlet component, and the concentrated water end of the RO membrane is respectively connected to the pre-water inlet component of the RO membrane, the auxiliary water inlet end of the electrolytic cell, and the water inlet end of the flushing component through the return water component, drainage component, and flushing component. When the device produces alkaline electrolyzed water, raw water undergoes purification through the RO membrane pre-purification component and the RO membrane to obtain pure water and concentrated water. The pure water enters the first water inlet of the electrolytic cell through the electrolytic cell water inlet component, and the concentrated water enters the second water inlet of the electrolytic cell through the drainage component. A direct current voltage is applied to the electrode plates of the electrolytic cell, where the electrode plate on the side of the first water inlet of the electrolytic cell is the cathode, and the electrode plate on the side of the second water inlet of the electrolytic cell is the anode. The following electrolysis reactions occur within the electrolytic cell:

anode side: 2H₂O−4e=O₂↑+4H (acidic,oxygen-rich water)

cathode side: 4H₂O+4e=2H₂↑+4OH⁻(alkaline,hydrogen-rich water)
under the action of a direct current electric field, some mineral ions (e.g., positive ions such as calcium, magnesium, iron, sodium, and zinc) in the concentrated water migrate through the cation membrane to the cathode side, which increases the mineral ions in the pure water on the cathode side to a certain extent, while other impurities in the concentrated water, such as bacteria, anions, and residual chlorine, are blocked by the high-density cation membrane. However, although mineral ions such as calcium and iron in concentrated water are isolated by the RO membrane, these mineral ions tend to adhere to the electrodes under the electrode reaction to form scale. When the scale accumulates to a certain extent, it will also affect the electrolysis efficiency.

### SUMMARY OF THE INVENTION

In view of the shortcomings of the prior art, an objective of the present invention is to provide a control circuit and a control method for a dual electrolyzed water preparation device based on parallel preparation of O₃ and H₂O₂.

The above technical objective of the present invention is achieved through the following technical solutions: a control circuit for a dual electrolyzed water preparation device based on parallel preparation of O₃ and H₂O₂, applied to control operation of a dual electrolyzed water preparation device through parallel preparation of O₃ and H₂O₂, including:
a touch key module interacting with an operator to output a start signal or a stop signal in response to an action of the operator;
a load driving module connected to the touch key module for obtaining the start signal or the stop signal to start or stop a load, wherein the load comprises an ozone generator;
a self-cleaning maintenance module connected to the load driving module for controlling output electrodes of the load driving module to perform polarity reversal and maintain normal operation of the load; and
a stabilized voltage power supply module connected to the touch key module, the load driving module, and the self-cleaning maintenance module for outputting multi-level driving voltages required to be supplied to the touch key module, the load driving module, and the self-cleaning maintenance module,
wherein the stabilized voltage power supply module supplies the multi-level driving voltages to power on the load driving module, and when the operator operates the touch key module to output the start signal to the load driving module, the ozone generator is started to electrolyze water to generate ozone and hydrogen peroxide, and when the self-cleaning maintenance module is started, the self-cleaning maintenance module performs output polarity reversal while driving the load to operate normally.

The present invention is further configured to: further include a pressure switch module, where the pressure switch module is used for acquiring pressure in a pipeline connected to the device, outputting a channel signal to the load driving module in response to an increase in the pressure in the pipeline, sending a power-off signal to the load driving module to shut down the device when the pressure is greater than a set reference pressure, and sending a power-on signal to the load driving module to resume operation of the device when the pressure is less than the set reference pressure.

The present invention is further configured such that: the load driving module includes a main control circuit and a polarity reversal switch circuit, where the main control circuit is connected to the touch key module and a polarity reversal switch circuit module, the polarity reversal switch circuit includes a positive electrode input switch circuit and a polarity reversal input switch circuit, the positive electrode input switch circuit and the polarity reversal input switch circuit include photoelectric couplers connected to the main control circuit, output terminals of the photoelectric couplers are connected to a power supply electrode and a switching transistor, respectively, a collector of the switching transistor is connected in series with relay switches to the power supply electrode, the emitter of the switching transistor is grounded, and a fixed resistor is electrically connected to the emitter and a base; and
two control terminals of the two relay switches are electrically connected to a power supply or grounded to form a power supply circuit at a positive electrode or a negative electrode of the load, respectively, and the main control circuit intermittently controls the two relay switches to work alternately to perform polarity reversal on positive and negative electrodes of the ozone generator.

The present invention is further configured such that: the pressure switch module includes a pressure sensor for monitoring pipeline pressure, and the pressure sensor is electrically connected with a coupler to the main control circuit for outputting a current cutoff signal to the main control circuit when the pressure acquired increases to a set threshold.

The present invention is further configured such that: the pressure sensor is sequentially connected with a voltage dividing circuit and a diode clamping circuit via a diode, and the voltage dividing circuit includes a voltage dividing resistor R7 and a voltage dividing resistor R6 arranged in series to be grounded, a formula for a voltage at an output terminal of the voltage dividing circuit is:

$${V}_{out} = {V}_{in} \text{?} \frac{R \text{?}}{R \text{?} + R \text{?}}$$

$$\text{?} \text{indicates text missing or illegible when filed}$$

and a connection terminal of the voltage dividing resistor R7 and the voltage dividing resistor R6 is connected with a current-limiting resistor R9.

The present invention is further configured such that: the diode clamping circuit includes two clamping diodes arranged in series, the two clamping diodes are sequentially arranged in series, and a common terminal of the two clamping diodes is connected to the current-limiting resistor R9 and electrically connected with an analog-to-digital converter.

The present invention is further configured such that: the pressure switch module further includes a switch coupler, the switch coupler is connected to the touch key module, an output terminal of the switch coupler and the coupler are connected to the main control circuit, respectively, one output terminal of each of the switch coupler and the coupler is grounded, the other output terminal of each of the switch coupler and the coupler is electrically connected with a pull-up resistor, respectively, and then connected to the power supply, and several filter capacitors are connected in parallel between the power supply and ground.

The present invention is further configured to: further include a scale detection module, where the scale detection module includes a rated resistor connected in series to a load electrode terminal, the rated resistor is connected in series to the load electrode terminal and then grounded, and the rated resistor and the load electrode terminal are jointly connected with a detector for detecting a voltage or current condition.

The present invention is further configured such that: the main control circuit is connected to the scale detection module for acquiring a scale condition of the load electrode terminal to adjust a frequency of polarity reversal for scale removal and jointly control the self-cleaning maintenance module: first, a scale degree S on the load electrode terminal is acquired through the scale detection module,

$$S = \frac{R \text{?} - R \text{?}}{R \text{?}} \text{?} 100 \% ,$$

$$\text{?} \text{indicates text missing or illegible when filed}$$

where R_{X} is a resistance after scale accumulation, and R₀ is a resistance value of the load electrode terminal in a scale-free state, then, a scale degree threshold T is set, when S>T, a polarity reversal frequency f is increased, f=fₘᵢₙ+k*(S−T), where fₘᵢₙ is a set minimum frequency, fₘₐₓ is a set maximum frequency, and the polarity reversal frequency f is within a range of [fₘᵢₙ, fₘₐₓ], and when S≤T, the polarity reversal frequency f is fₘᵢₙ.

A control method for a dual electrolyzed water preparation device based on parallel preparation of O₃ and H₂O₂, adopting the control circuit for a dual electrolyzed water preparation device based on parallel preparation of O₃ and H₂O₂, including the following control steps:
starting: outputting, by the operator, a switch signal through the touch key module, during the first interaction, outputting the switch signal as the start signal to the main control circuit, simultaneously outputting, by the main control circuit, mirror-set pulse signals to the positive electrode input switch circuit and the polarity reversal input switch circuit, and when the positive electrode input switch circuit receives a low-level signal and the polarity reversal input switch circuit receives a high-level signal, starting, by the main control circuit, the load, so that the ozone generator and a hydrogen peroxide generator start to work to electrolyze water to generate O₃ and H₂O₂;
scale monitoring: after the device is started, monitoring resistance conditions, i.e., conditions of Rₓ values, of electrodes of the ozone generator and the hydrogen peroxide generator in real time through the scale detection module, calculating the scale degree of the load electrode terminal according to

$$S = \frac{R \text{?} - R \text{?}}{R \text{?}} \text{?} 100 \% ,$$

$$\text{?} \text{indicates text missing or illegible when filed}$$

and feeding back the scale degree of the load electrode terminal in real time by the main control circuit;
polarity reversal control: according to the scale degree S fed back in real time, dynamically adjusting, by the main control circuit, the polarity reversal frequency f, wherein when S≤T, the polarity reversal frequency f is fₘᵢₙ, when S>T, the polarity reversal frequency f is increased to fₘₐₓ, the polarity reversal frequency is increased, and a k value is adjusted according to a sensitivity requirement,

$$0.01 Hz / \% \leq k \leq \frac{\text{?}}{S \text{?} - T} ;$$

$$\text{?} \text{indicates text missing or illegible when filed}$$

and
pressure monitoring: after the device is started, simultaneously acquiring a pressure condition in an input pipeline or an output pipeline through the pressure switch module, when the pressure condition in the input pipeline or the output pipeline increases and is greater than the set threshold, outputting a low-level current cutoff signal to the switch coupler, receiving, by the main control circuit, a high-level power-off signal, stopping the load driving module, and when the pressure condition in the input pipeline or the output pipeline decreases and is less than the set threshold, outputting a high-level channel signal to the switch coupler, and resuming operation of the load driving module.

In summary, the present invention has the following beneficial effects:
a scale degree is monitored in real time through a resistance detection method, and a polarity reversal frequency is dynamically adjusted, thereby effectively preventing accumulation of scale. In addition, the polarity reversal frequency can be automatically and adaptively adjusted according to the scale degree, reducing an impact on the device.

### BRIEF DESCRIPTION OF THE DRAWINGS

FIG. 1 is a system block diagram of the present invention;

FIG. 2 is a schematic circuit diagram of a touch key module in the present invention;

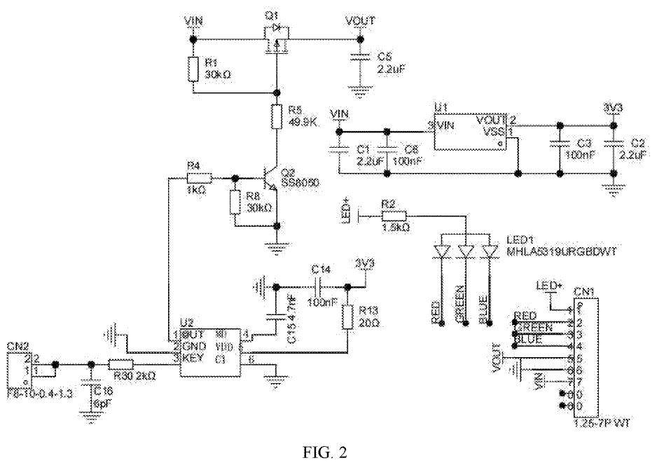

FIG. 3 is a schematic circuit diagram of a stabilized voltage power supply module in the present invention;

FIG. 4 is a schematic circuit diagram of a main control circuit in the present invention;

FIG. 5 is a schematic circuit diagram of a polarity reversal switch circuit in the present invention; and

FIG. 6 is a schematic circuit diagram of a pressure switch module in the present invention.

### DETAILED DESCRIPTION OF EMBODIMENTS

The technical solutions in the embodiments of the present invention will be described clearly and completely below in conjunction with the embodiments of the present invention. Obviously, the described embodiments are merely some rather than all of the embodiments of the present invention. On the basis of the embodiments of the present invention, all other embodiments obtained by persons of ordinary skill in the art without exerting creative efforts shall fall within the scope of protection of the present invention.

### Embodiment 1

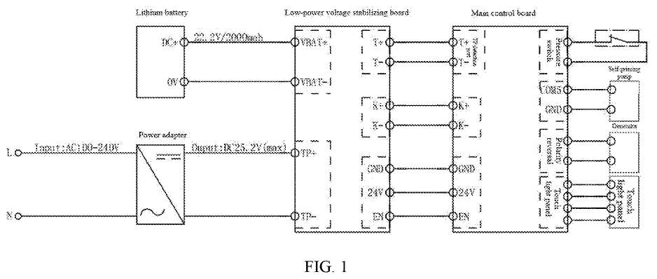

As shown in FIG. 1, a control circuit for a dual electrolyzed water preparation device based on parallel preparation of O₃ and H₂O₂, applied to control operation of a dual electrolyzed water preparation device through parallel preparation of O₃ and H₂O₂, including:
a touch key module interacting with an operator to output a start signal or a stop signal in response to an action of the operator;
a load driving module connected to the touch key module for acquiring the start signal or the stop signal to start or stop a load, where the load includes an ozone generator;
a self-cleaning maintenance module connected to the load driving module for controlling output electrodes of the load driving module to perform polarity reversal and maintain normal operation of the load; and
a stabilized voltage power supply module connected to the touch key module, the load driving module, and the self-cleaning maintenance module for outputting multi-level driving voltages required to be supplied to the touch key module, the load driving module, and the self-cleaning maintenance module,
wherein the stabilized voltage power supply module supplies the multi-level driving voltages to power on the load driving module, and when the operator operates the touch key module to output the start signal to the load driving module, the ozone generator is started to electrolyze water to generate ozone and hydrogen peroxide, and when the self-cleaning maintenance module is started, the self-cleaning maintenance module performs output polarity reversal while driving the load to operate normally.

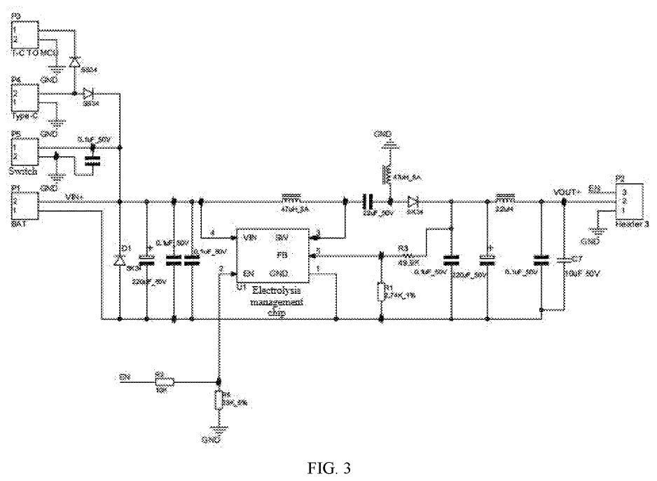

As shown in FIG. 3, in this embodiment, the stabilized voltage power supply module includes a power management chip. The power management chip has a VIN terminal, an EN pin, a SW pin, an FB pin, and a GND terminal. Specifically, several filter capacitors are arranged between the VIN terminal and the GND terminal of the power management chip, and a Schottky diode is connected in parallel therewith to play a role in preventing reverse connection, which avoids damage to the power management chip caused by reverse connection. In addition, an energy storage component is connected to the VIN terminal and the GND terminal of the power management chip. In this embodiment, a lithium battery is selected as the energy storage component, and the energy storage component is electrically connected with a Type-C interface for connecting a power adapter and a driver chip for the Type-C interface.

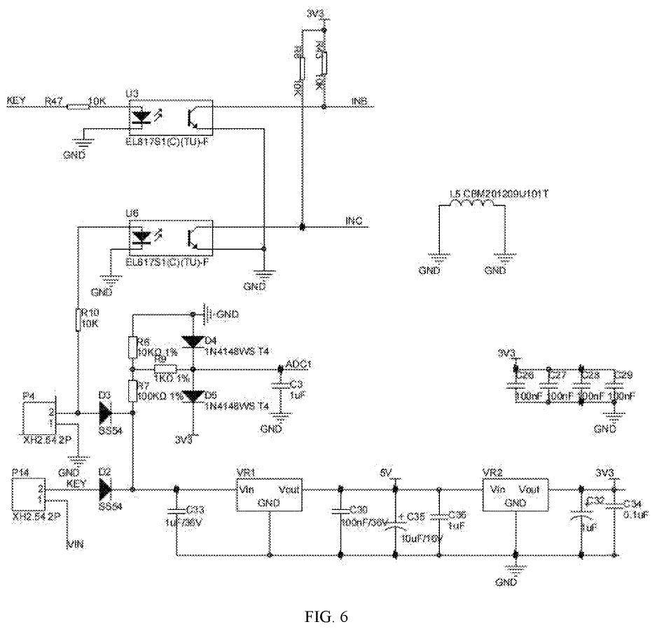

As shown in FIG. 6, a pressure switch module is further included, the pressure switch module is used for acquiring pressure in a pipeline connected to the device, outputting a channel signal to the load driving module in response to an increase in the pressure in the pipeline, sending a power-off signal to the load driving module to shut down the device when the pressure is greater than a set reference pressure, and sending a power-on signal to the load driving module to resume operation of the device when the pressure is less than the set reference pressure. In this embodiment, the pressure switch module includes a pressure sensor for monitoring pipeline pressure, and the pressure sensor is electrically connected with a coupler to the main control circuit for outputting a current cutoff signal to the main control circuit when the pressure acquired increases to a set threshold. By adopting the pressure sensor in the pressure switch module, the pressure in the pipeline is acquired through the pressure sensor. However, when the pipeline is blocked due to bending, an electrolysis instrument can be automatically shut down when the pressure is too high. Alternatively, for application control, a user can also turn on or off the electrolysis instrument through a water path on-off switch of a hand-held shower during use, thereby achieving flexible control of a working state of the electrolysis instrument through a pipeline switch.

The pressure sensor is sequentially connected with a voltage dividing circuit and a diode clamping circuit via a diode, and the voltage dividing circuit includes a voltage dividing resistor R7 and a voltage dividing resistor R6 arranged in series to be grounded, a formula for a voltage at an output terminal of the voltage dividing circuit is:

$${V}_{out} = {V}_{in} \text{?} \frac{R \text{?}}{R \text{?} + R \text{?}} ,$$

$$\text{?} \text{indicates text missing or illegible when filed}$$

and a connection terminal of the voltage dividing resistor R7 and the voltage dividing resistor R6 is connected with a current-limiting resistor R9, where the diode clamping circuit includes two clamping diodes arranged in series, the two clamping diodes are sequentially arranged in series, and a common terminal of the two clamping diodes is connected to the current-limiting resistor R9 and electrically connected with an analog-to-digital converter.

As shown in FIG. 6, the pressure switch module further includes a switch coupler, the switch coupler is connected to the touch key module, an output terminal of the switch coupler and the coupler are connected to the main control circuit, respectively, one output terminal of each of the switch coupler and the coupler is grounded, the other output terminal of each of the switch coupler and the coupler is electrically connected with a pull-up resistor, respectively, and then connected to the power supply, and several filter capacitors are connected in parallel between the power supply and ground.

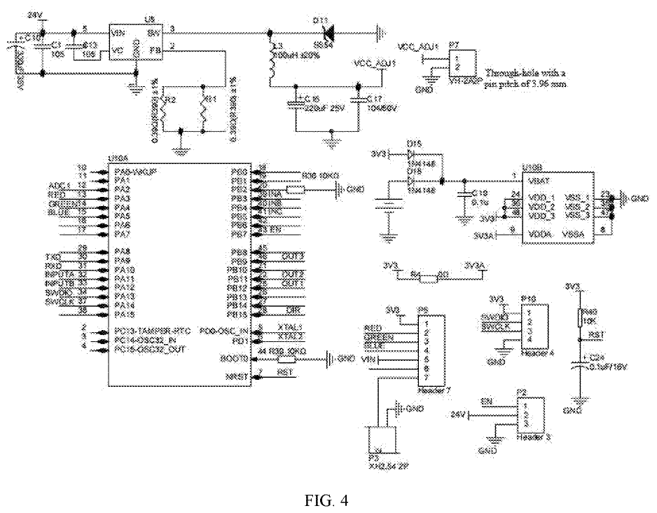

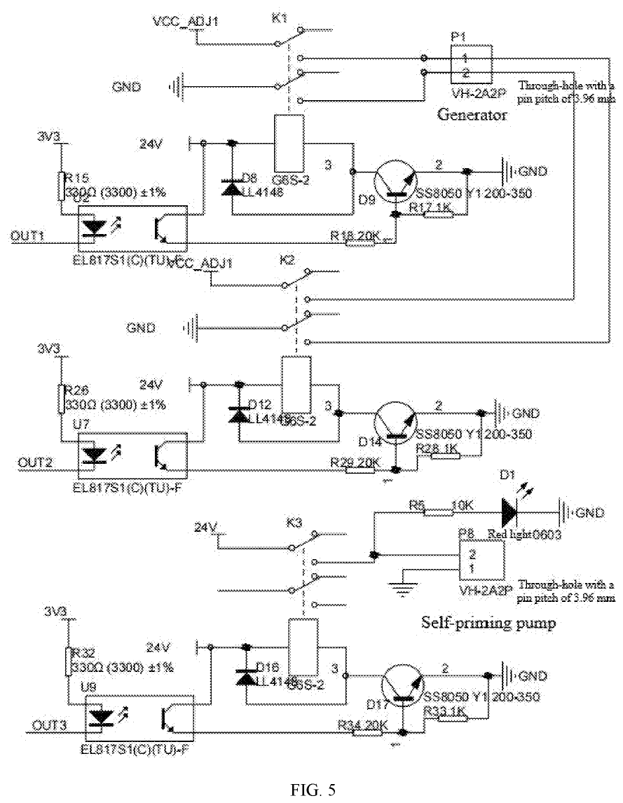

As shown in FIG. 4 and FIG. 5, the load driving module includes a main control circuit and a polarity reversal switch circuit, where the main control circuit is connected to the touch key module and a polarity reversal switch circuit module, the polarity reversal switch circuit includes a positive electrode input switch circuit and a polarity reversal input switch circuit, the positive electrode input switch circuit and the polarity reversal input switch circuit include photoelectric couplers connected to the main control circuit, output terminals of the photoelectric couplers are connected to a power supply electrode and a switching transistor, respectively, a collector of the switching transistor is connected in series with relay switches to the power supply electrode, the emitter of the switching transistor is grounded, and a fixed resistor is electrically connected to the emitter and a base, where two control terminals of the two relay switches are electrically connected to a power supply or grounded to form a power supply circuit at a positive electrode or a negative electrode of the load, respectively, and the main control circuit intermittently controls the two relay switches to work alternately to perform polarity reversal on positive and negative electrodes of the ozone generator.

A scale detection module is further included, where the scale detection module includes a rated resistor connected in series to a load electrode terminal, the rated resistor is connected in series to the load electrode terminal and then grounded, and the rated resistor and the load electrode terminal are jointly connected with a detector for detecting a voltage or current condition. The main control circuit is connected to the scale detection module for acquiring a scale condition of the load electrode terminal to adjust a frequency of polarity reversal for scale removal and jointly control the self-cleaning maintenance module: first, a scale degree S on the load electrode terminal is acquired through the scale detection module,

$$S = \frac{R \text{?} - R \text{?}}{R \text{?}} \text{?} 100 \% ,$$

$$\text{?} \text{indicates text missing or illegible when filed}$$

where R_{X} is a resistance after scale accumulation, and R₀ is a resistance value of the load electrode terminal in a scale-free state, then, a scale degree threshold T is set, when S>T, a polarity reversal frequency f is increased, f=fₘᵢₙ+k*(S−T), where fₘᵢₙ is a set minimum frequency, fₘₐₓ is a set maximum frequency, and the polarity reversal frequency f is within a range of [fₘᵢₙ, fₘₐₓ], and when S≤T, the polarity reversal frequency f is fₘᵢₙ.

### Embodiment 2

A control method for a dual electrolyzed water preparation device based on parallel preparation of O₃ and H₂O₂, adopting the control circuit as recorded in Embodiment 1, including the following control steps:
starting: outputting, by the operator, a switch signal through the touch key module, during the first interaction, outputting the switch signal as the start signal to the main control circuit, simultaneously outputting, by the main control circuit, mirror-set pulse signals to the positive electrode input switch circuit and the polarity reversal input switch circuit, and when the positive electrode input switch circuit receives a low-level signal and the polarity reversal input switch circuit receives a high-level signal, starting, by the main control circuit, the load, so that the ozone generator and a hydrogen peroxide generator start to work to electrolyze water to generate O₃ and H₂O₂;
scale monitoring: after the device is started, monitoring resistance conditions, i.e., conditions of R_{X} values, of electrodes of the ozone generator and the hydrogen peroxide generator in real time through the scale detection module, calculating the scale degree of the load electrode terminal according to

$$S = \frac{R \text{?} - R \text{?}}{R \text{?}} \text{?} 100 \% ,$$

$$\text{?} \text{indicates text missing or illegible when filed}$$

and feeding back the scale degree of the load electrode terminal in real time by the main control circuit;
polarity reversal control: according to the scale degree S fed back in real time, dynamically adjusting, by the main control circuit, the polarity reversal frequency f, where when S≤T,
the polarity reversal frequency f is fₘᵢₙ, when S>T, the polarity reversal frequency f is increased to fₘₐₓ, the polarity reversal frequency is increased, and a k value is adjusted according to a sensitivity requirement,

$$0.01 Hz / \% \leq k \leq \frac{\text{?}}{S \text{?} - T} ;$$

$$\text{?} \text{indicates text missing or illegible when filed}$$

and
pressure monitoring: after the device is started, simultaneously acquiring a pressure condition in an input pipeline or an output pipeline through the pressure switch module, when the pressure condition in the input pipeline or the output pipeline increases and is greater than the set threshold, outputting a low-level current cutoff signal to the switch coupler, receiving, by the main control circuit, a high-level power-off signal, stopping the load driving module, and when the pressure condition in the input pipeline or the output pipeline decreases and is less than the set threshold, outputting a high-level channel signal to the switch coupler, and resuming operation of the load driving module.

For example, in this embodiment, the resistance value of R₀ is set to 10Ω, the scale degree threshold T is set to 20%, fₘᵢₙ is 0.1 Hz, fₘₐₓ is 10 Hz, and the value of k is 0.1. When it is measured that there is less scale, the value of the resistor Rₓ is 11Ω. The scale degree S=((11−10)/10)*100%=10%. At this time, S<T, so the polarity reversal frequency is f=fₘᵢₙ=0.1 Hz. When there is much scale, the measured resistance value of the resistor Rₓ is 15Ω. The scale degree S=((15−10)/10)*100%=50%. It is measured that S=50%>20%, so the polarity reversal frequency f=0.1+0.1× (50−20)=3.1 Hz.
a scale degree is monitored in real time through a resistance detection method, and a polarity reversal frequency is dynamically adjusted, thereby effectively preventing accumulation of scale. In addition, the polarity reversal frequency can be automatically and adaptively adjusted according to the scale degree, reducing an impact on the device.

The above description is merely a preferred embodiment of the present invention, and the scope of protection of the present invention is not limited to the above embodiments. All technical solutions falling within the concept of the present invention shall fall within the scope of protection of the present invention. It should be noted that for those of ordinary skill in the art, several improvements and modifications can be made without departing from the principles of the present invention, and these improvements and modifications shall also be regarded as the scope of protection of the present invention.

What is claimed is:

1. A control circuit for a dual electrolyzed water preparation device based on parallel preparation of O₃ and H₂O₂, applied to control operation of a dual electrolyzed water preparation device through parallel preparation of O₃ and H₂O₂, comprising:
a touch key module interacting with an operator to output a start signal or a stop signal in response to an action of the operator;
a load driving module connected to the touch key module for obtaining the start signal or the stop signal to start or stop a load, wherein the load comprises an ozone generator;
a self-cleaning maintenance module connected to the load driving module for controlling output electrodes of the load driving module to perform polarity reversal and maintain normal operation of the load; and
a stabilized voltage power supply module connected to the touch key module, the load driving module, and the self-cleaning maintenance module for outputting multi-level driving voltages required to be supplied to the touch key module, the load driving module, and the self-cleaning maintenance module,
wherein the stabilized voltage power supply module supplies the multi-level driving voltages to power on the load driving module, and when the operator operates the touch key module to output the start signal to the load driving module, the ozone generator is started to electrolyze water to generate ozone and hydrogen peroxide, and when the self-cleaning maintenance module is started, the self-cleaning maintenance module performs output polarity reversal while driving the load to operate normally.

2. The control circuit for a dual electrolyzed water preparation device based on parallel preparation of O₃ and H₂O₂ according to claim 1, further comprising a pressure switch module, wherein the pressure switch module is used for acquiring pressure in a pipeline connected to the device, outputting a channel signal to the load driving module in response to an increase in the pressure in the pipeline, sending a power-off signal to the load driving module to shut down the device when the pressure is greater than a set reference pressure, and sending a power-on signal to the load driving module to resume operation of the device when the pressure is less than the set reference pressure.

3. The control circuit for a dual electrolyzed water preparation device based on parallel preparation of O₃ and H₂O₂ according to claim 2, wherein the load driving module comprises a main control circuit and a polarity reversal switch circuit, wherein the main control circuit is connected to the touch key module and a polarity reversal switch circuit module, the polarity reversal switch circuit comprises a positive electrode input switch circuit and a polarity reversal input switch circuit, the positive electrode input switch circuit and the polarity reversal input switch circuit comprise photoelectric couplers connected to the main control circuit, output terminals of the photoelectric couplers are connected to a power supply electrode and a switching transistor, respectively, a collector of the switching transistor is connected in series with relay switches to the power supply electrode, the emitter of the switching transistor is grounded, and a fixed resistor is electrically connected to the emitter and a base; and
two control terminals of the two relay switches are electrically connected to a power supply or grounded to form a power supply circuit at a positive electrode or a negative electrode of the load, respectively, and the main control circuit intermittently controls the two relay switches to work alternately to perform polarity reversal on positive and negative electrodes of the ozone generator.

4. The control circuit for a dual electrolyzed water preparation device based on parallel preparation of O₃ and H₂O₂ according to claim 3, wherein the pressure switch module comprises a pressure sensor for monitoring pipeline pressure, and the pressure sensor is electrically connected with a coupler to the main control circuit for outputting a current cutoff signal to the main control circuit when the pressure acquired increases to a set threshold.

5. The control circuit for a dual electrolyzed water preparation device based on parallel preparation of O₃ and H₂O₂ according to claim 4, wherein the pressure sensor is sequentially connected with a voltage dividing circuit and a diode clamping circuit via a diode, and the voltage dividing circuit comprises a voltage dividing resistor R7 and a voltage dividing resistor R6 arranged in series to be grounded, a formula for a voltage at an output terminal of the voltage dividing circuit is:
$${V}_{out} = {V}_{in} \text{?} \frac{R \text{?}}{R \text{?} + R \text{?}} ,$$
$$\text{?} \text{indicates text missing or illegible when filed}$$
and a connection terminal of the voltage dividing resistor R7 and the voltage dividing resistor R6 is connected with a current-limiting resistor R9.

6. The control circuit for a dual electrolyzed water preparation device based on parallel preparation of O₃ and H₂O₂ according to claim 5, wherein the diode clamping circuit comprises two clamping diodes arranged in series, the two clamping diodes are sequentially arranged in series, and a common terminal of the two clamping diodes is connected to the current-limiting resistor R9 and electrically connected with an analog-to-digital converter.

7. The control circuit for a dual electrolyzed water preparation device based on parallel preparation of O₃ and H₂O₂ according to claim 4, wherein the pressure switch module further comprises a switch coupler, the switch coupler is connected to the touch key module, an output terminal of the switch coupler and the coupler are connected to the main control circuit, respectively, one output terminal of each of the switch coupler and the coupler is grounded, the other output terminal of each of the switch coupler and the coupler is electrically connected with a pull-up resistor, respectively, and then connected to the power supply, and several filter capacitors are connected in parallel between the power supply and ground.

8. The control circuit for a dual electrolyzed water preparation device based on parallel preparation of O₃ and H₂O₂ according to claim 3, further comprising a scale detection module, wherein the scale detection module comprises a rated resistor connected in series to a load electrode terminal, the rated resistor is connected in series to the load electrode terminal and then grounded, and the rated resistor and the load electrode terminal are jointly connected with a detector for detecting a voltage or current condition.

9. The control circuit for a dual electrolyzed water preparation device based on parallel preparation of O₃ and H₂O₂ according to claim 8, wherein the main control circuit is connected to the scale detection module for obtaining a scale condition of the load electrode terminal to adjust a frequency of polarity reversal for scale removal and jointly control the self-cleaning maintenance module: first, a scale degree S on the load electrode terminal is acquired through the scale detection module,
$$S = \frac{R \text{?} - R \text{?}}{R \text{?}} \text{?} 100 \% ,$$
$$\text{?} \text{indicates text missing or illegible when filed}$$
wherein R_{X} is a resistance after scale accumulation, and R₀ is a resistance value of the load electrode terminal in a scale-free state, then, a scale degree threshold T is set, when S>T, a polarity reversal frequency f is increased, f=fₘᵢₙ+k*(S−T), wherein fₘᵢₙ is a set minimum frequency, fₘₐₓ is a set maximum frequency, and the polarity reversal frequency f is within a range of [fₘᵢₙ, fₘₐₓ], and when S≤T, the polarity reversal frequency f is fₘᵢₙ.

10. A control method for a dual electrolyzed water preparation device based on parallel preparation of O₃ and H₂O₂, adopting the control circuit for a dual electrolyzed water preparation device based on parallel preparation of O₃ and H₂O₂ according to claim 1, comprising the following control steps:
starting: outputting, by the operator, a switch signal through the touch key module, during the first interaction, outputting the switch signal as the start signal to the main control circuit, simultaneously outputting, by the main control circuit, mirror-set pulse signals to the positive electrode input switch circuit and the polarity reversal input switch circuit, and when the positive electrode input switch circuit receives a low-level signal and the polarity reversal input switch circuit receives a high-level signal, starting, by the main control circuit, the load, so that the ozone generator and a hydrogen peroxide generator start to work to electrolyze water to generate O₃ and H₂O₂;
scale monitoring: after the device is started, monitoring resistance conditions, i.e., conditions of R_{X} values, of electrodes of the ozone generator and the hydrogen peroxide generator in real time through the scale detection module, calculating the scale degree of the load electrode terminal according to
$$S = \frac{R \text{?} - R \text{?}}{R \text{?}} \text{?} 100 \% ,$$
$$\text{?} \text{indicates text missing or illegible when filed}$$
and feeding back the scale degree of the load electrode terminal in real time by the main control circuit;
polarity reversal control: according to the scale degree S fed back in real time, dynamically adjusting, by the main control circuit, the polarity reversal frequency f, wherein when S≤T, the polarity reversal frequency f is fₘᵢₙ, when S>T, the polarity reversal frequency f is increased to fₘₐₓ, the polarity reversal frequency is increased, and a k value is adjusted according to a sensitivity requirement,
$$0.01 Hz / \% \leq k \leq \frac{\text{?}}{S \text{?} - T} ;$$
$$\text{?} \text{indicates text missing or illegible when filed}$$
and
pressure monitoring: after the device is started, simultaneously acquiring a pressure condition in an input pipeline or an output pipeline through the pressure switch module, when the pressure condition in the input pipeline or the output pipeline increases and is greater than the set threshold, outputting a low-level current cutoff signal to the switch coupler, receiving, by the main control circuit, a high-level power-off signal, stopping the load driving module, and when the pressure condition in the input pipeline or the output pipeline decreases and is less than the set threshold, outputting a high-level channel signal to the switch coupler, and resuming operation of the load driving module.
